(19) United States
(12) Patent Application Publication
(10) Pub. No.: US 2024/0384573 A1
(43) Pub. Date: Nov. 21, 2024

(54) ALIGNMENT TOOL FOR A CLOSURE LATCH FOR A VEHICLE

(71) Applicant: Rivian IP Holdings, LLC, Irvine, CA (US)

(72) Inventors: Carlos Miguel CHON, Aliso Viejo, CA (US); Ashish GUPTA, Bloomington, IL (US); David Philip BOYER, Irvine, CA (US); Julio Cesar MALDONADO, Canton, MI (US); Victor Daniel ROJAS, Hermosa Beach, CA (US); Alfonso MARQUEZ LOPEZ, Newport Beach, CA (US)

(21) Appl. No.: 18/319,370

(22) Filed: May 17, 2023

(51) Int. Cl. E05B 79/08; E05B 85/04

(52) U.S. Cl. CPC E05B 79/08; E05B 85/04

(57) ABSTRACT

An apparatus for aligning a latch to a striker of a vehicle door is provided. The apparatus includes a frame configured to be attached to the vehicle door, and a base coupled to the frame. The frame includes a body, a first arm and a second arm. The body defines an opening configured to receive the striker. The first arm extends from the body, and includes a first inner surface. The second arm extends from the body, and includes a second inner surface. The base includes an upper surface that defines a recess that extends inward from the end that abuts the frame. The recess is configured to receive a portion of the striker that passes through the opening in the frame. The first inner surface, the second inner surface, and the upper surface are configured to align the latch to the striker when the vehicle door is closed.

### INTRODUCTION

The present disclosure relates to a vehicle. More particularly, the present disclosure relates to an alignment tool for a closure latch (or latch) of a vehicle.

### SUMMARY

Embodiments of the present disclosure advantageously provide an apparatus for aligning a latch to a striker of a vehicle door. The apparatus includes a frame configured to be attached to the vehicle door, and a base coupled to the frame. The frame includes a body, a first arm and a second arm. The body defines an opening configured to receive the striker. The first arm extends from the body, and includes a first inner surface. The second arm extends from the body, and includes a second inner surface. The base includes an upper surface that defines a recess that extends inward from the end that abuts the frame. The recess is configured to receive a portion of the striker that passes through the opening in the frame. The first inner surface, the second inner surface, and the upper surface are configured to align the latch to the striker when the vehicle door is closed.

### BRIEF DESCRIPTION OF THE DRAWINGS

FIG. 1 depicts a portion of a vehicle body with an open compartment door and a latch assembly, in accordance with embodiments of the present disclosure.

FIG. 2 depicts a portion of a vehicle body with a latch assembly and a closed door with a striker, in accordance with embodiments of the present disclosure.

FIG. 3 depicts an alignment tool during the installation or adjustment of a latch assembly, in accordance with embodiments of the present disclosure.

FIG. 4 depicts a front view of an alignment tool with a striker and a latch assembly, in accordance with embodiments of the present disclosure.

FIG. 5 depicts a perspective view of an alignment tool with portions of an inner body panel of a vehicle door, a striker and a striker post, in accordance with embodiments of the present disclosure.

FIG. 6 depicts a perspective view of an alignment tool, in accordance with embodiments of the present disclosure.

FIGS. 7A to 7F depict front, back, top, bottom, left and right views of an alignment tool, respectively, in accordance with embodiments of the present disclosure.

FIG. 8 depicts a frame and a base of an alignment tool, in accordance with embodiments of the present disclosure.

FIGS. 9A and 9B depict flow charts representing functionality associated with aligning a latch to a striker of a vehicle door, in accordance with embodiments of the present disclosure.

### DETAILED DESCRIPTION

Certain embodiments herein are generally directed to features for an alignment tool for installing a latch for a vehicle door, such as a stowage compartment, a hood, a trunk, a cabin door, etc. During the assembly or repair of a vehicle, the fitment of a latch for a vehicle door is an iterative manual process, in which the latch is mounted to the vehicle body, the door is closed, and the alignment of the latch and the door striker is observed. If the latch does not properly secure the door striker in the closed (or latched) position, the mounting of the latch is adjusted based on the observation, and the process is repeated until the latch properly secures the door striker in the closed position. The mounting bracket for the latch may allow adjustment in two directions, such that the position of the latch with respect to the door striker can be adjusted.

Due to manufacturing tolerances, the amount of adjustment required to properly secure the door striker in the closed position may create an undesirable misalignment between the latch and the door striker. This misalignment interferes with the operation of the latch and prevents the door from properly opening. Additionally, the misalignment may interfere with the proper alignment of the door to the vehicle body, which causes overflush and underflush conditions.

For example, the misalignment may cause the door striker to drag against a portion of the latch when the latch is released from the latched position and prevent the door from opening to its proper extent. When the latch has a power cinch mechanism, the latch may simply re-latch the door when the opening is too small. When the latch does not have a power cinch mechanism, the user may not be able to grasp the edge of the door when the opening is too small, or the user may not be able to overcome the stiction (i.e., static friction) created by the contact between the door striker and the latch. Similarly, the misalignment may cause the door striker to drag against a portion of the latch when the door is closed, which makes it difficult for the user to secure the latch in the latched position.

Embodiments of the present disclosure advantageously improve the installation of the latch by aligning the latch to the center of the swing of the post of the door striker. This improved installation reduces the angular variation of the door latch relative to the door, reduces excessive mechanical play of the latch inside the vehicle, and mitigates overflush and underflush conditions with respect to the alignment of the door to the vehicle body.

In certain aspects, an apparatus is provided for aligning a latch to a striker of a vehicle door. The apparatus includes a frame configured to be attached to the vehicle door, and a base coupled to the frame. The frame includes a body, a first arm and a second arm. The body defines an opening configured to receive the striker. The first arm extends from the body, and includes a first inner surface. The second arm extends from the body, and includes a second inner surface. The base includes an upper surface that defines a recess that extends inward from the end that abuts the frame. The recess is configured to receive a portion of the striker that passes through the opening in the frame. The first inner surface, the second inner surface, and the upper surface are configured to align the latch to the striker when the vehicle door is closed.

In certain aspects, the apparatus also includes a number of removable shims. In such aspects, the body defines at least one recess, and each recess is configured to receive one of the removable shims. The shims correct overflush and underflush conditions with respect to the alignment of the door to the vehicle body.

In certain aspects, the base is removably coupled to the frame. The body defines a first channel and a second channel, and the base includes a first guide and a second guide. The first guide extends from the end that abuts the frame, and is configured to slidingly engage the first channel. The second guide also extends from the end that abuts the frame, and is configured to slidingly engage the second channel. In certain aspects, the first arm has a first lower surface that includes a first magnet, the second arm has a second lower surface that includes a second magnet, and the upper surface includes a pair of magnets that are configured to respectively cooperate with the first magnet and the second magnet to removably couple the base to the frame.

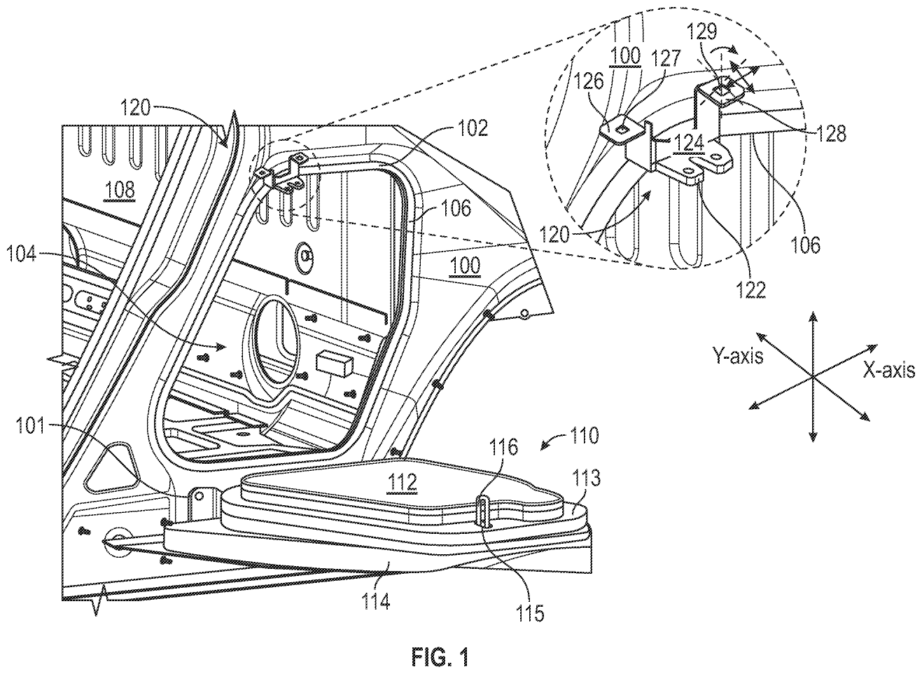

FIG. 1 depicts a portion of vehicle body 100 with door 110 and latch assembly 120, in accordance with embodiments of the present disclosure.

Vehicle body 100 includes door perimeter 102 that defines opening 104 that is configured to receive door 110. Gasket 106 may be attached to door perimeter 102 to provide a weathertight or watertight seal when door 110 is closed. In this example, door 110 provides access to compartment 108, such as a gear tunnel, a cargo compartment, a luggage compartment, an electronic systems compartment, an energy storage (battery) compartment, etc., and is depicted in an open position.

Door 110 includes, inter alia, liner panel 112, inner body panel 113, outer body panel 114, and striker 116. Hinge 101 is attached to vehicle body 100 and door 110. In certain embodiments, hinge 101 has an axis of rotation that is parallel to one of the major vehicle axes, such as the X axis. For convenience, the X axis is parallel to the longitudinal axis of the vehicle, the Y axis is parallel to the transverse axis of the vehicle, and the Z axis is parallel to the vertical axis of the vehicle (as depicted in FIG. 1). In other embodiments, hinge 101 may have any axis of rotation.

Hinge 101 rotationally couples door 110 to vehicle body 100. In many embodiments, door 110 is manually operated, and gravity assists the opening of door 110 and opposes the closing of door 110. In certain embodiments, hinge 101 may include, or be coupled to, a damper that applies a retarding force to door 110 during opening, or, alternatively, applies a retarding force to door 110 during both opening and closing. In other embodiments, hinge 101 may be spring-loaded, counter-balanced, electrically-powered, etc.

Inner body panel 113 is attached to liner panel 112 and outer body panel 114. Inner body panel 113 defines opening 115 that is configured to receive striker 116, and may include a recessed perimeter that cooperates with gasket 106 to form a weathertight or watertight seal when door 110 is closed. Striker 116 is attached to outer body panel 114, and a portion of striker 116 passes through opening 115 in inner body panel 113. In many embodiments, striker 116 is made of steel, a magnetic material, a ferromagnetic material, etc.

Latch assembly 120 includes, inter alia, latch 122 and bracket 124. Latch 122 may be electrically or mechanically operated, and has a latched state and an unlatched state. In the latched state, door 110 is closed and latch 122 is engaged to striker 116. In the unlatched state, latch 122 is disengaged from striker 116, and door 110 may be at least partially open. When latch 122 is not properly aligned with striker 116, the unlatched state may not provide a large enough opening between door 110 and gasket 106 to allow door 110 to be opened manually, or may cause a powered door closing mechanism, powered cinching mechanism, etc., to close and re-latch door 110.

In many embodiments, bracket 124 includes mounting arm 126 and mounting arm 128. In other embodiments, a single mounting arm or support may be used, three (or more) mounting arms may be used, etc. Mounting arm 126 has an upper surface that defines opening 127 which allows the passage of one end of a fastener, such as a bolt, etc., to attach latch assembly 120 to a fastener retainer, such as a threaded insert, a nut retainer, a cage nut, etc., attached to vehicle body 100. Similarly, mounting arm 128 has an upper surface that defines opening 129 which allows the passage of one end of a fastener, such as a bolt, etc., to attach latch assembly 120 to a fastener retainer, such as a threaded insert, a nut retainer, a cage nut, etc., attached to vehicle body 100. Openings 127 and 129 may be square, rectangular, circular, oval, etc.

Generally, openings 127 and 129 are larger than the diameter (or largest dimension) of the fastener to allow the adjustment of latch assembly 120 in one or more directions (one or more degrees of freedom) with respect to striker 116. In many embodiments, latch assembly 120 may be independently adjusted along the X axis, and independently adjusted along the Y axis. These two degrees of freedom also allow latch assembly 120 to be rotated about the Z axis (a redundant degree of freedom). In certain embodiments, latch assembly 120 may be independently adjusted along the X axis up to ±3 mm and independently adjusted along the Y axis up to ±3 mm, which allows rotation about the Z axis up to ±8°.

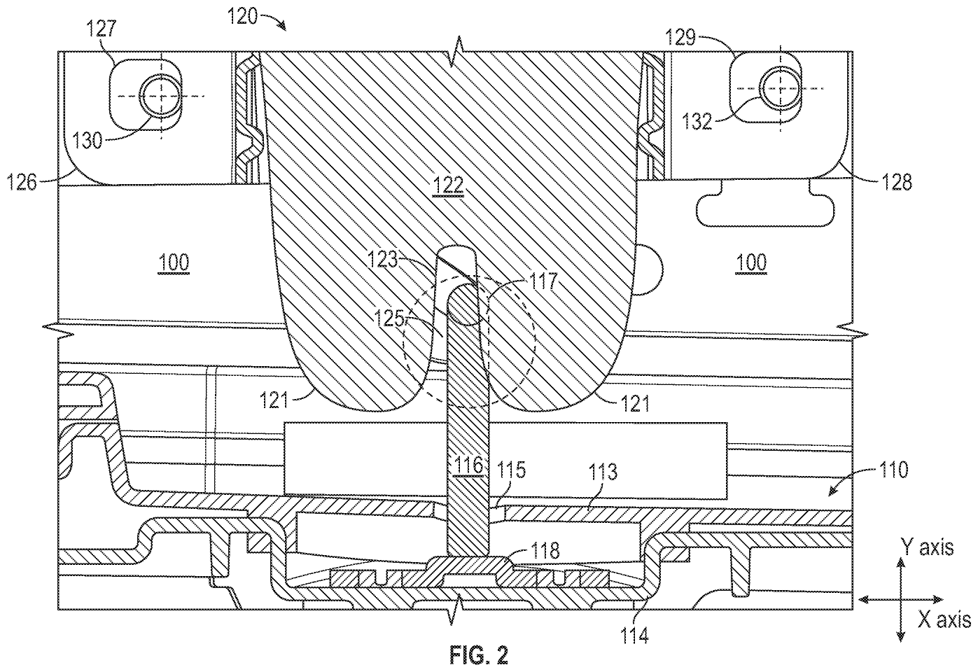

FIG. 2 depicts a portion of vehicle body 100 with latch assembly 120, and door 110 with striker 116, in accordance with embodiments of the present disclosure.

Striker bracket 118 attaches striker 116 to outer body panel 114, and a majority of striker 116 passes through opening 115 of inner body panel 113. Fasteners 130, 132 respectively cooperate with mounting arms 126, 128 to attach latch assembly 120 to vehicle body 100. The distal portion of latch 122 defines passage 123 that is configured to receive the distal portion of striker 116 including post 117, which is engaged by lock mechanism 125 enclosed within the distal portion of latch 122. Door 110 is depicted in a closed position.

In order to for lock mechanism 125 to engage post 117 of striker 116 in this example, latch assembly 120 must be manually adjusted to the maximum possible displacement along the positive X axis, as shown by the contact of fastener 130 with the inner surface of opening 127 of mounting arm 126, and the contact of fastener 132 with the inner surface of opening 129 of mounting arm 128. Due to the angular misalignment between passage 123 and striker 116, mechanical interference between striker 116 and latch 122 will prevent the proper adjustment of latch assembly 120.

While latch assembly 120 may continue to be manually adjusted, in practice, it is difficult to reduce or remove this mechanical interference. Striker 116 will then drag against the surface of passage 123 of latch 122 when latch 122 is released from the latched position and may prevent door 110 from opening to its proper extent. Similarly, striker 116 will drag against the surface of passage 123 of latch 122 when door 110 is closed, which makes it difficult for the user to secure latch 122 in the latched position.

Embodiments of the present disclosure advantageously provide an alignment tool that improves the installation of latch assembly 120 by aligning latch 122 to the center of the swing of post 117 of striker 116, which reduces the angular misalignment of latch 122 relative to striker 116 of door 110, and reduces or removes any mechanical interference between these components.

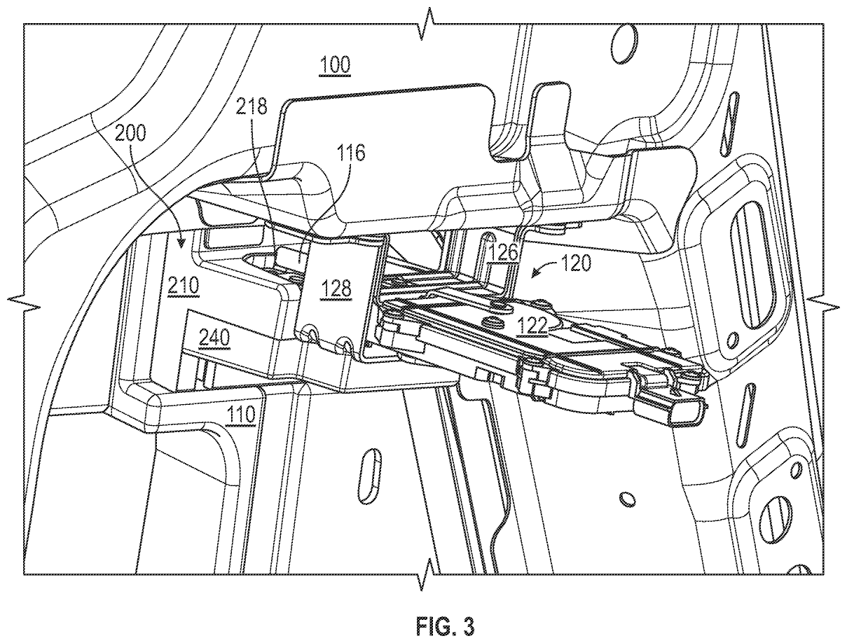

FIG. 3 depicts alignment tool 200 during the installation or adjustment of latch assembly 120, in accordance with embodiments of the present disclosure.

Alignment tool 200 includes, inter alia, frame 210 and base 240. Frame 210 defines opening 218, which is configured to receive striker 116. Base 240 is configured to support latch 122 during installation or adjustment, and defines a recess (not visible) configured to receive a portion of striker 116 and post 117. Base 240 may be a separate component that is removably or permanently attached to frame 210. Alternatively, frame 210 and base 240 may be formed as a single component. In many embodiments, frame 210 may include a magnet (not visible) to magnetically couple latch 122 to frame 210 during installation or adjustment.

Advantageously, the installation or adjustment of latch assembly 120 is simpler when compared to the existing iterative and inaccurate process. Door 110 is rotated to the open (or partially open) position, and alignment tool 200 is attached to the region of inner body panel 113 that surrounds striker 116 such that striker 116 is received by, and extends through, opening 218.

In certain embodiments, base 240 is slidingly attached to frame 210 and may be displaced away from frame 210 to accommodate a striker 116 with a long post 117. In other embodiments, alignment tool 200 may include several bases 240, each having a recess with a different depth to receive strikers 116 with posts 117 of different lengths.

In many embodiments, latch assembly 120 may be loosely attached to vehicle body 100 by inserting fasteners 130, 132 (not visible) through openings 127, 129 (not visible) in mounting arms 126, 128, and then partially securing fasteners 130, 132 to respective fastener retainers in vehicle body 100 to allow translation (in two dimensions) and rotation of latch assembly 120 with respect to striker 116 and door 110. Latch 122 is then guided into the proper position and orientation by alignment tool 200 as door 110 is closed. Fasteners 130, 132 are then secured to attach latch assembly 120 to vehicle body 100.

In other embodiments, latch 122 may be engaged to striker 116 and magnetically secured to, and supported by, alignment tool 200 in the proper position and orientation. Door 110 may then be closed, and fasteners 130, 132 may be inserted through openings 127, 129 and secured to attach latch assembly 120 to vehicle body 100.

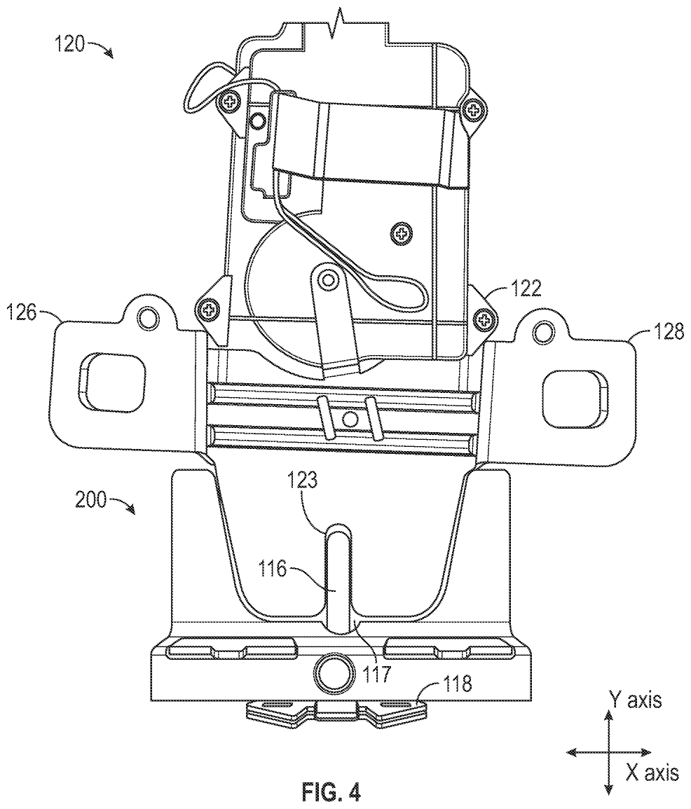

FIG. 4 depicts a front view of alignment tool 200 with striker 116 and latch assembly 120, in accordance with embodiments of the present disclosure.

The same views of striker 116, striker bracket 118, and latch assembly 120 are presented in FIGS. 2 and 4. Alignment tool 200 is shown supporting latch assembly 120 in the proper position and orientation. More particularly, alignment tool 200 is shown supporting the front, left side, right side, and bottom portions of the distal end of latch 122. A portion of striker 116 is disposed within passage 123, and locking mechanism 125 (not visible) of latch 122 has engaged post 117.

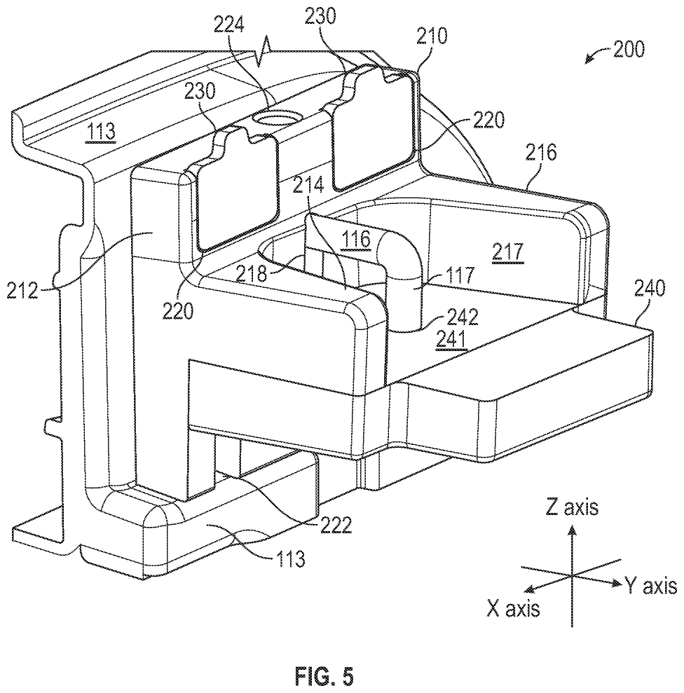

FIG. 5 depicts a perspective view of alignment tool 200 with portions of inner body panel 113, striker 116 and post 117, in accordance with embodiments of the present disclosure.

Frame 210 includes, inter alia, body 212, arm 214, and arm 216.

Body 212 defines opening 218 that is configured to receive striker 116. In many embodiments, body 212 also defines one or more recesses 220, and each recess 220 is configured to receive one of a number of removable shims 230. Each removable shim 230 has a different thickness, and the insertion of an appropriate removable shim 230 into recess 220 advantageously corrects for overflush or underflush conditions of door 110 with respect to vehicle body 100. In certain embodiments, body 212 defines two recesses 220, and a pair of removable shims 230 having the same thickness may be inserted to correct for overflush or underflush conditions. In many embodiments, body 212 also defines one or more channels 222, and each channel 222 is configured to receive a respective guide 244 (not visible) of base 240.

Arm 214 extends from body 212, and includes an inner surface 215 (not visible) that conforms to the exterior profile of a portion of the distal end of latch 122. In many embodiments, at least a portion of inner surface 215 is arcuate (or curved). Similarly, arm 216 extends from body 212, and includes an inner surface 217 that conforms to the exterior profile of another portion of the distal end of latch 122. In many embodiments, at least a portion of inner surface 217 is arcuate (or curved).

Base 240 includes upper surface 241 that defines recess 242 that extends inward from the end that abuts frame 210. Recess 242 is configured to receive a portion of striker 116 that passes through opening 218 in frame 210. Base 240 also includes one or more guides 244 (not visible). Each guide 244 slidingly engages a respective channel 222 to couple base 240 to frame 210. In many embodiments, channels 222 and guides 244 have T-shaped cross-sections.

In many embodiments, magnets 246 (not visible) may be embedded in upper surface 241 to cooperate with respective magnets embedded in the lower surface of arm 214 and the lower surface of arm 216 to magnetically couple base 240 to frame 210.

In many embodiments, magnet 224 may be embedded within body 212 to magnetically couple frame 210 to striker 116, and magnet 226 (not visible) may be embedded within body 212 to magnetically couple frame 210 to striker 116. Magnet 224 may also magnetically couple latch 122 to alignment tool 200 during installation or adjustment.

Advantageously, inner surface 215, inner surface 217, and upper surface 241 are configured to align latch 122 to striker 116 when vehicle door 110 is closed.

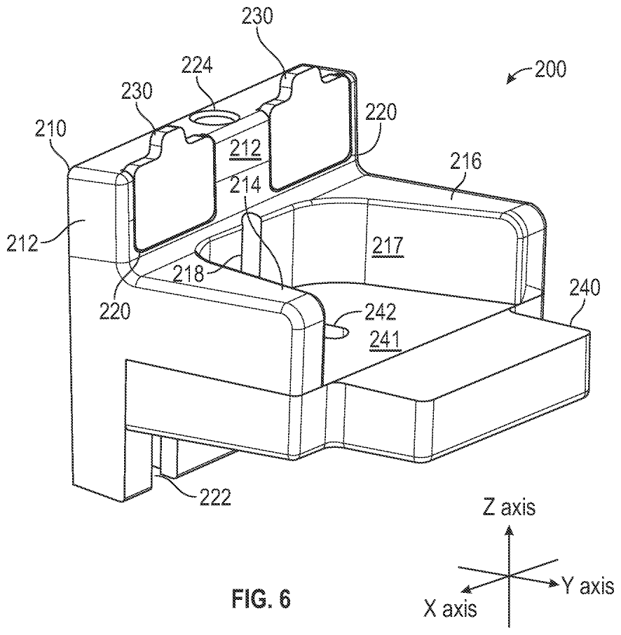

FIG. 6 depicts a perspective view of alignment tool 200, in accordance with embodiments of the present disclosure.

The same views of alignment tool 200 are presented in FIGS. 5 and 6. More particularly, frame 210, body 212, arm 214, arm 216, inner surface 217, opening 218, recesses 220, channel 222, magnet 224, removable shims 230, base 240, upper surface 241, and recess 242 have been identified in FIG. 6.

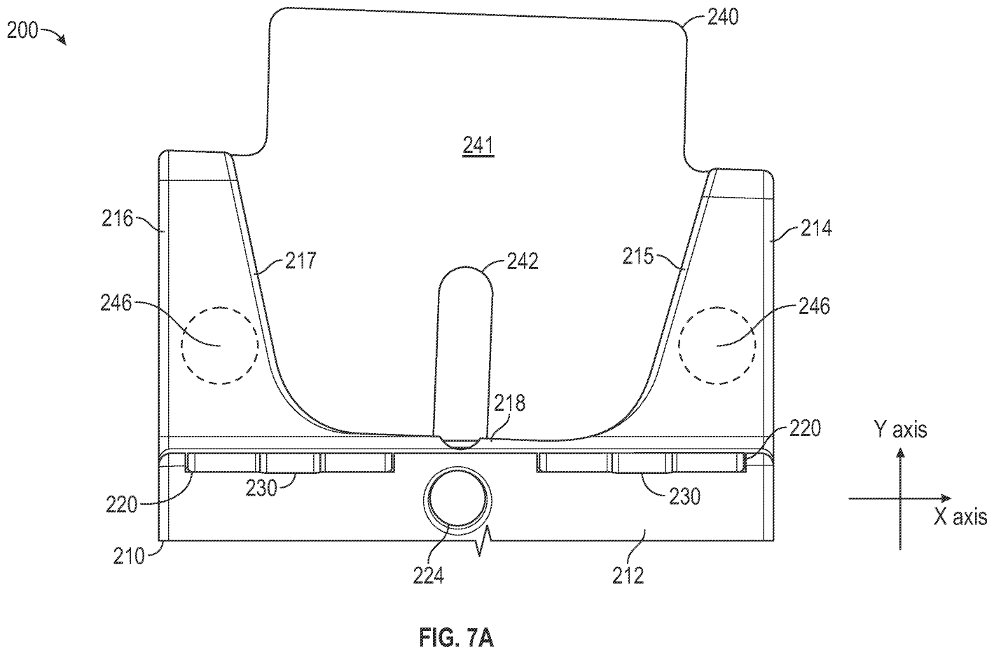

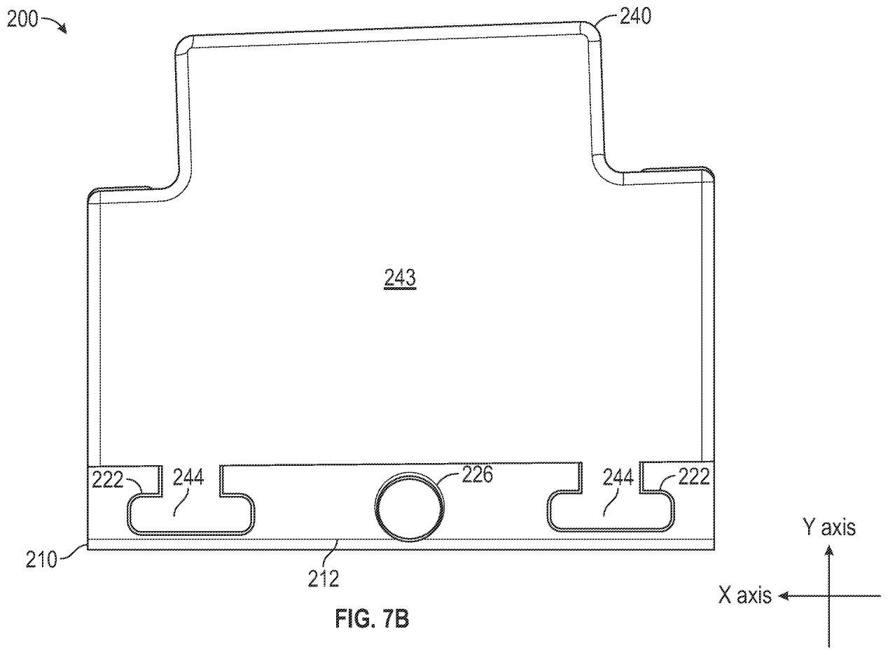

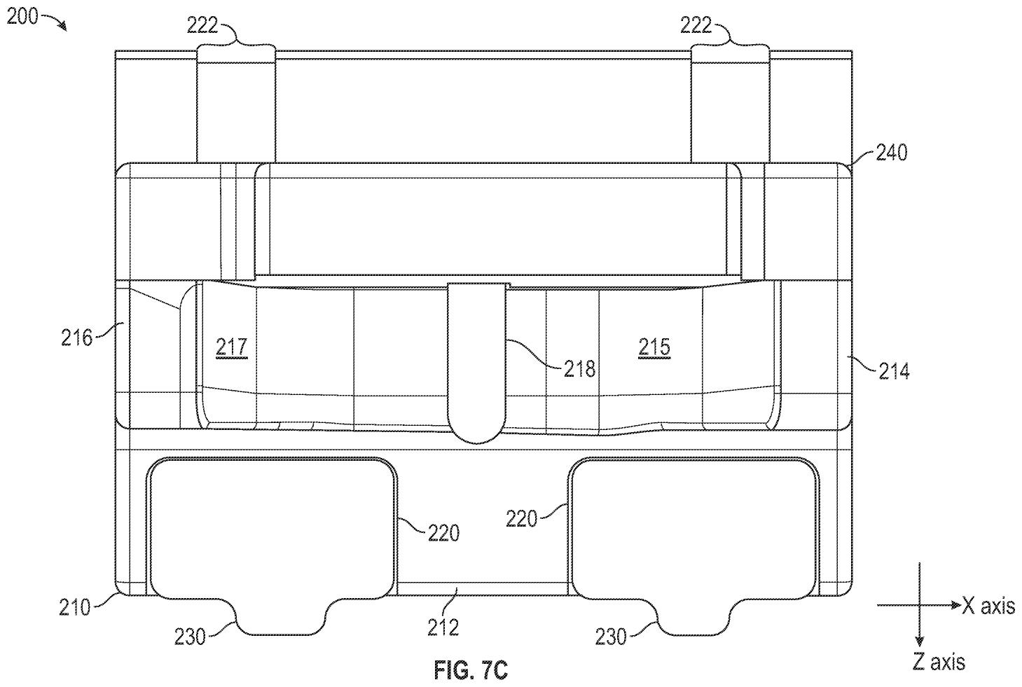

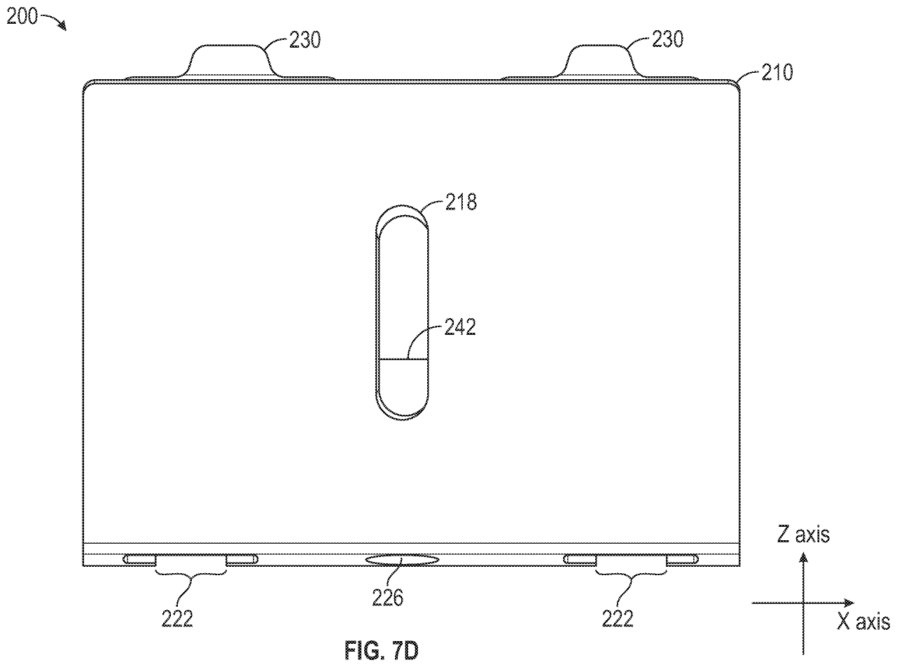

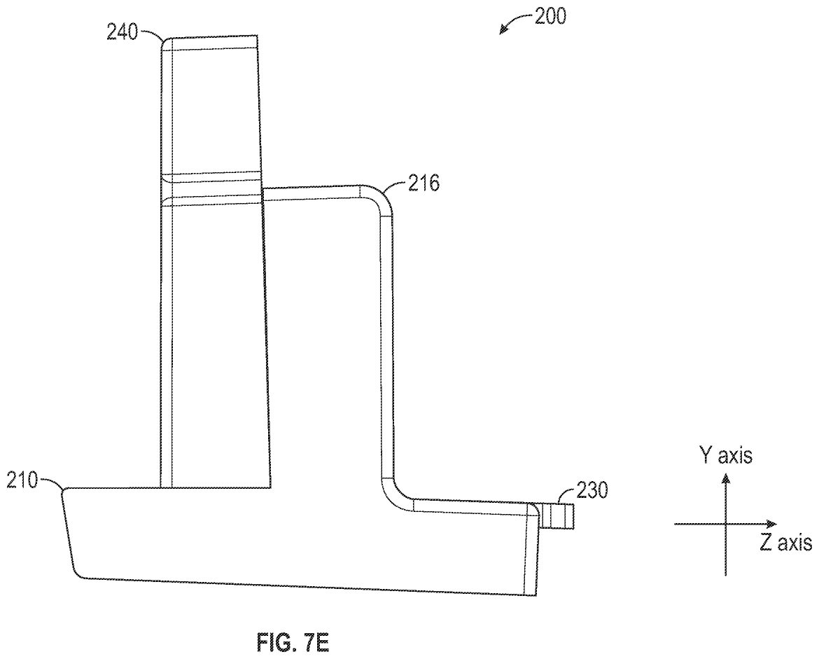

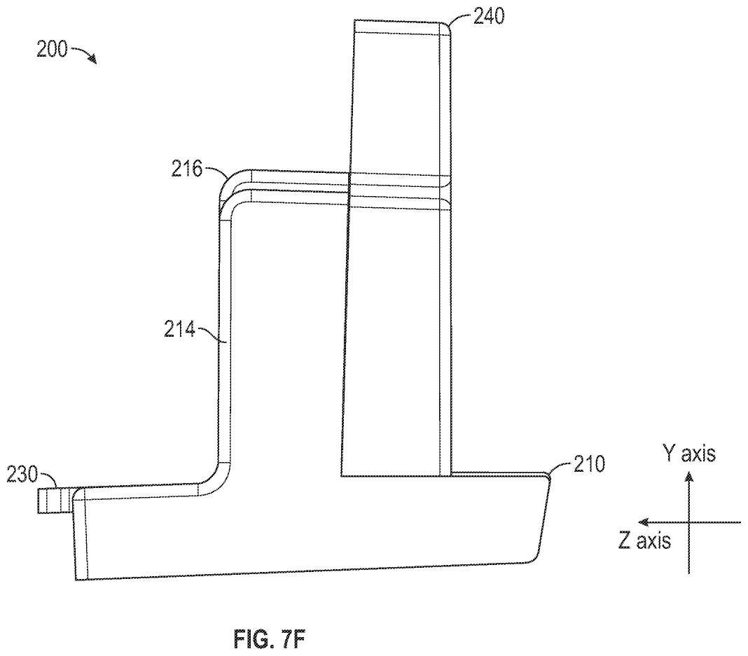

FIGS. 7A to 7F depict front, back, top, bottom, left and right views of alignment tool 200, respectively, in accordance with embodiments of the present disclosure.

FIG. 7A presents a front view of alignment tool 200, in accordance with embodiments of the present disclosure. More particularly, frame 210, body 212, arm 214, inner surface 215, arm 216, inner surface 217, opening 218, recesses 220, magnet 224, removable shims 230, base 240, upper surface 241, recess 242, and magnets 246 have been identified in FIG. 7A.

FIG. 7B presents a back view of alignment tool 200, in accordance with embodiments of the present disclosure. More particularly, frame 210, body 212, channels 222, magnet 226, base 240, lower surface 243, and guides 244 have been identified in FIG. 7B.

FIG. 7C presents a top view of alignment tool 200, in accordance with embodiments of the present disclosure. More particularly, frame 210, body 212, arm 214, inner surface 215, arm 216, inner surface 217, opening 218, recesses 220, channels 222, removable shims 230, and base 240 have been identified in FIG. 7C.

FIG. 7D presents a bottom view of alignment tool 200, in accordance with embodiments of the present disclosure. More particularly, frame 210, opening 218, channels 222, magnet 226, removable shims 230, and recess 242 have been identified in FIG. 7D.

FIG. 7E presents a left view of alignment tool 200, in accordance with embodiments of the present disclosure. More particularly, frame 210, arm 216, removable shims 230, and base 240 have been identified in FIG. 7E.

FIG. 7F presents a right view of alignment tool 200, in accordance with embodiments of the present disclosure. More particularly, frame 210, arm 214, arm 216, removable shims 230, and base 240 have been identified in FIG. 7F.

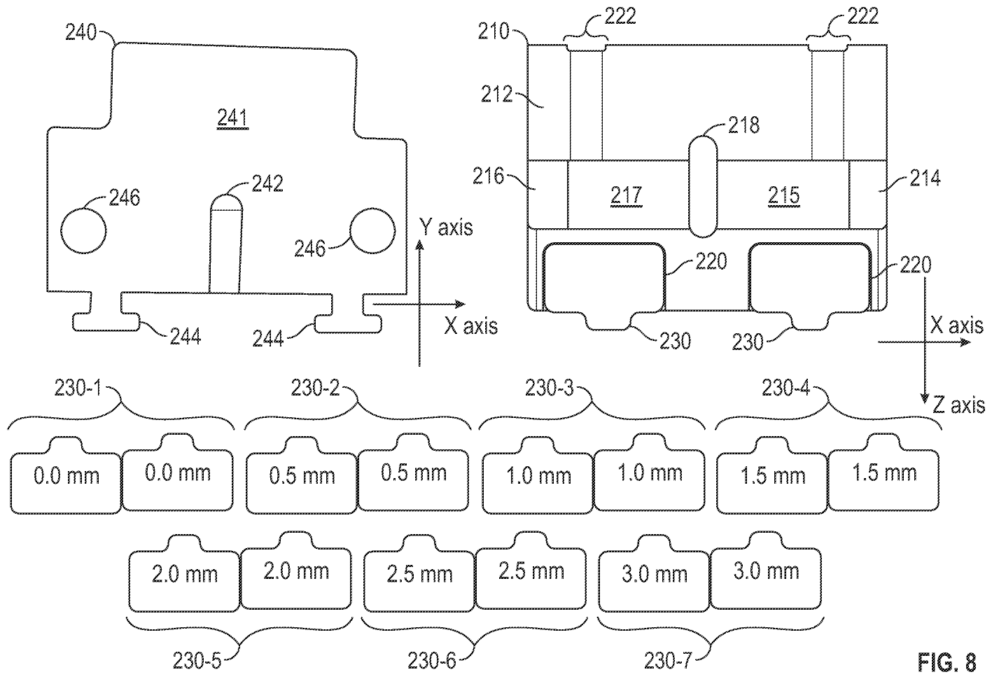

FIG. 8 depicts frame 210 and base 240 of alignment tool 200, in accordance with embodiments of the present disclosure.

The top view of frame 210 is depicted, including body 212, arm 214, inner surface 215, arm 216, inner surface 217, opening 218, recesses 220, channels 222, and removable shims 230 have been identified. The front view of base 240 is also depicted, including upper surface 241, recess 242, guides 244, and magnets 246.

A number of pairs of removable shims 230-i are also depicted, ranging in thickness from 0.0 mm (i.e., flush with the surface of body 212) to 3.0 mm. Each removable shim 230-1 has a thickness of 0.0 mm, each removable shim 230-2 has a thickness of 0.5 mm, each removable shim 230-3 has a thickness of 1.0 mm, each removable shim 230-4 has a thickness of 1.5 mm, each removable shim 230-5 has a thickness of 2.0 mm, each removable shim 230-6 has a thickness of 2.5 mm, and each removable shim 230-7 has a thickness of 3.0 mm. In many embodiments, each removable shim 230 has a thickness between 0.0 mm and 3.0 mm inclusive. In other embodiments, the maximum thickness may be greater than 3.00 mm, the difference in thickness between shim pairs may be less than 0.5 mm (such as 0.1 mm, 0.2 mm, etc.), the difference in thickness between shim pairs may be non-uniform (such as 0.1 mm between the first pair, 0.2 mm between the second pair, etc.), etc.

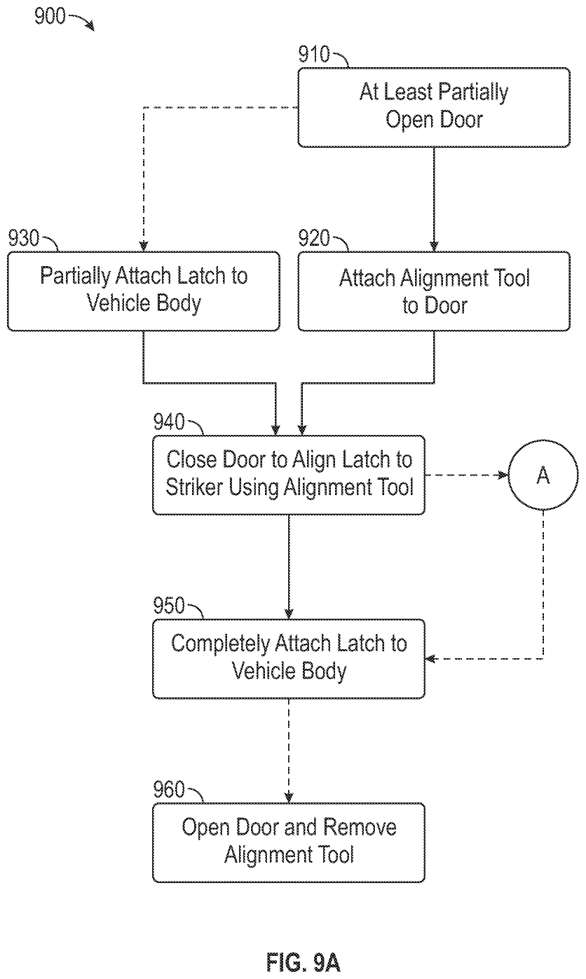

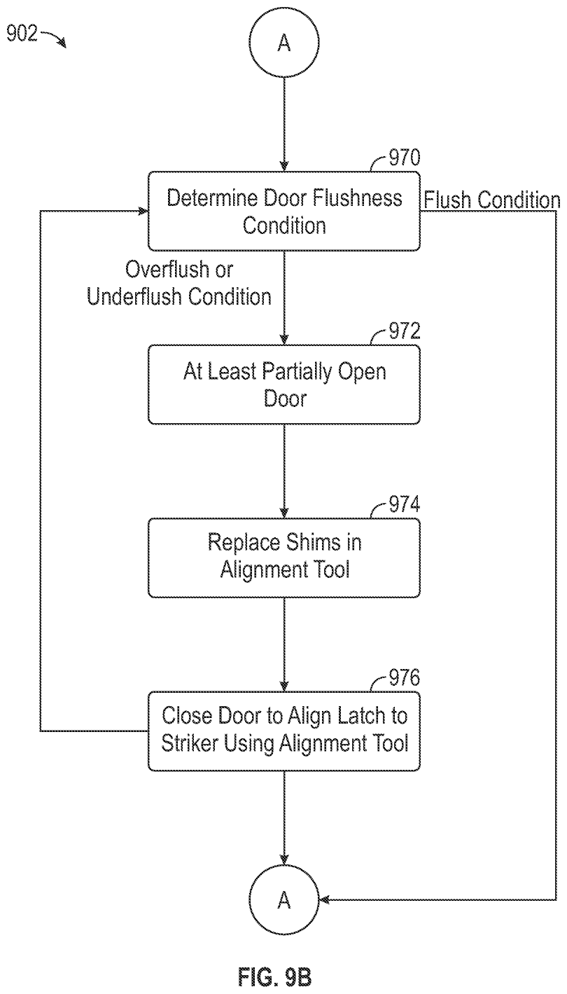

FIG. 9A depicts flow chart 900 representing functionality associated with aligning a latch to a striker of a vehicle door, in accordance with embodiments of the present disclosure.

Advantageously, the installation or adjustment of latch assembly 120 is simpler when compared to the existing iterative and inaccurate process.

At 910, door 110 is opened by rotating door 110 to the open (or partially open) position. In other words, door 110 is at least partially opened.

At 920, alignment tool 200 is attached to door 110. For example, alignment tool 200 is attached to the region of inner body panel 113 of door 110 that surrounds striker 116, which includes passing striker 116 through opening 218 such that striker 116 is received by, and extends through, opening 218. In certain embodiments, alignment tool 200 may be magnetically attached to striker 116 of door 110 by magnet 224 and/or magnet 226.

At 930, latch 122 is partially attached to vehicle body 100. In many embodiments, latch assembly 120 may be loosely attached to vehicle body 100 by inserting fasteners 130, 132 through openings 127, 129 in mounting arms 126, 128, and then partially securing fasteners 130, 132 to respective fastener retainers in vehicle body 100 to allow translation (in two dimensions) and rotation of latch assembly 120 with respect to striker 116 and door 110.

At 940, door 110 is closed by rotating door 110 to the closed position, and latch 122 is guided into the proper position and orientation by inner surface 215, inner surface 217, and upper surface 241 of alignment tool 200 as door 110 is closed. In other words, the inner surface 215, 217 of arms 214, 216 of frame 210 and upper surface 241 of base 240 cooperate to align latch 122 to striker 116 when door 110 closes.

At 950, fasteners 130, 132 is secured to attach latch assembly 120 to vehicle body 100. At 960, door 110 is opened and alignment tool 200 is removed.

FIG. 9B depicts flow chart 902 representing further functionality associated with aligning a latch to a striker of a vehicle door, in accordance with embodiments of the present disclosure.

In certain embodiments, the flushness condition of door 110 with respect to vehicle body 100 may be checked and adjusted (flow connector “A” in FIGS. 9A and 9B). After 940, flow proceeds to 970.

At 970, the flushness condition of door 110 with respect to vehicle body 100 is determined. When door 110 is determined to be flush with vehicle body 100 (i.e., the “flush condition”), flow proceeds to 950.

When door 110 is determined to be overflush or underflush with vehicle body 100 (i.e., the “overflush condition” or the “underflush condition”), flow proceeds to 972.

At 972, door 110 is opened by rotating door 110 to the open (or partially open) position. In other words, door 110 is at least partially opened.

At 974, at least one removable shim 230 is replaced with a thinner removable shim 230 for an overflush condition, and a thicker removable shim 230 for an underflush condition.

At 976, door 110 is closed by rotating door 110 to the closed position, and latch 122 is guided into the proper position and orientation by inner surface 215, inner surface 217, and upper surface 241 of alignment tool 200 as door 110 is closed.

Flow returns to 970 for another flushness determination, and 972, 974 and 986 may be repeated until the flush condition is achieved.

The many features and advantages of the disclosure are apparent from the detailed specification, and, thus, it is intended by the appended claims to cover all such features and advantages of the disclosure which fall within the scope of the disclosure. Further, since numerous modifications and variations will readily occur to those skilled in the art, it is not desired to limit the disclosure to the exact construction and operation illustrated and described, and, accordingly, all suitable modifications and equivalents may be resorted to that fall within the scope of the disclosure.

What is claimed is:

1. An apparatus for aligning a latch to a striker of a vehicle door, the apparatus comprising:
a frame configured to be attached to the vehicle door, the frame including:
a body defining an opening configured to receive the striker,
a first arm extending from the body and including a first inner surface, and
a second arm extending from the body and including a second inner surface; and
a base coupled to the frame, the base including:
an upper surface defining a recess extending inward from an end, the recess configured to receive a portion of the striker,
wherein the first inner surface, the second inner surface, and the upper surface are configured to align the latch to the striker when the vehicle door is closed.

2. The apparatus of claim 1, wherein at least a portion of the first inner surface is arcuate, and at least a portion of the second inner surface is arcuate.

3. The apparatus of claim 1, further comprising:
a plurality of removable shims,
wherein the body defines at least one recess, and each recess is configured to receive one of the removable shims.

4. The apparatus of claim 3, wherein the removable shims are configured to adjust a flushness of the vehicle door with respect to a vehicle body.

5. The apparatus of claim 4, wherein each removable shim has a thickness between 0.0 mm and 3.0 mm inclusive.

6. The apparatus of claim 5, wherein the body defines two recesses, the plurality of removable shims include pairs of removable shims, and each pair of removable shims has a same thickness.

7. The apparatus of claim 1, wherein the base is removably coupled to the frame.

8. The apparatus of claim 7, wherein:
the body defines at least one channel; and
the base includes at least one guide, each guide extending from the end and configured to slidingly engage a respective channel.

9. The apparatus of claim 8, wherein:
the body defines a first channel and a second channel; and
the base includes:
a first guide extending from the end and configured to slidingly engage the first channel, and
a second guide extending from the end and configured to slidingly engage the second channel.

10. The apparatus of claim 9, wherein the first channel, the second channel, the first guide, and the second guide have T-shaped cross-sections.

11. The apparatus of claim 7, wherein the base is magnetically coupled to the frame.

12. The apparatus of claim 11, wherein:
a first magnet is embedded in a lower surface of the first arm;
a second magnet is embedded in a lower surface of the second arm;
a third magnet is embedded in the upper surface of the base to cooperate with the first magnet; and
a fourth magnet is embedded in the upper surface of the base to cooperate with the second magnet.

13. The apparatus of claim 1, wherein the body includes a magnet configured to magnetically couple the frame to the striker.

14. The apparatus of claim 1, wherein the body includes a magnet configured to magnetically couple the latch to the frame.

15. A method for aligning a latch to a striker of a vehicle door, the method comprising:
at least partially opening the vehicle door;
attaching an alignment tool to the vehicle door, including passing the striker through an opening in the alignment tool;
partially attaching the latch to a vehicle body;
closing the vehicle door to align the latch to the striker using the alignment tool; and
completely attaching the latch to the vehicle body.

16. The method of claim 15, wherein:
the alignment tool includes a frame and a base;
the frame includes two arms, each arm has an inner surface, and each inner surface is at least partially arcuate;
the base has an upper surface; and
the inner surfaces of the arms of the frame and the upper surface of the base cooperate to align the latch to the striker when the door closes.

17. The method of claim 15, wherein:
the alignment tool includes at least one magnet; and
the attaching the alignment tool includes magnetically attaching the alignment tool to the striker of the vehicle door.

18. The method of claim 15, wherein the alignment tool includes at least one replaceable shim, and the method further comprises:
determining a door flushness condition; and
when the door flushness condition is an overflush condition:
at least partially opening the vehicle door,
replacing the at least one replaceable shim with a thinner replaceable shim, and
closing the vehicle door to align the latch to the striker using the alignment tool.

19. The method of claim 18, further comprising:
when the door flushness condition is an underflush condition:
at least partially opening the vehicle door;
replacing the at least one replaceable shim with a thicker replaceable shim; and
closing the vehicle door to align the latch to the striker using the alignment tool.

20. The method of claim 15, further comprising opening the vehicle door and detaching the alignment tool from the vehicle door.
